(19) United States
(12) Patent Application Publication
(10) Pub. No.: US 2026/0257751 A1
(43) Pub. Date: Sep. 3, 2026

(54) SADDLED VEHICLE

(71) Applicant: HONDA MOTOR CO., LTD., Tokyo (JP)

(72) Inventors: Atsushi Ogahara, Minato-ku, Tokyo (JP); Tsubasa Nose, Minato-ku, Tokyo (JP); Chikashi Iizuka, Minato-ku, Tokyo (JP); Masaki Nakagawara, Minato-ku, Tokyo (JP); Masaki Naito, Minato-ku, Tokyo (JP); Kiyotaka Sakai, Minato-ku, Tokyo (JP); Hiroshi Maeda, Wako-shi, Saitama (JP)

(21) Appl. No.: 18/718,456

(22) PCT Filed: Sep. 5, 2022
(86) PCT No.: PCT/JP2022/033311

§ 371 Date: Jun. 11, 2024

(30) Foreign Application Priority Data
Dec. 24, 2021 (JP) 2021-211367

(51) Int. Cl. B62K 21/08

(52) U.S. Cl. CPC B62K 21/08

(57) ABSTRACT

A saddle-ride vehicle that can apply damping force without interfering with operation of a rider. The saddle-ride vehicle includes a vehicle body including: a handle that steers a steering wheel; vibration detector that detects vibration of the handle; a steering actuator that applies torque in a steering direction to a suspension apparatus supporting a steering wheel; and a control apparatus that controls the steering actuator to apply the torque to the suspension apparatus, in which the control apparatus performs control to apply torque to the suspension apparatus to suppress the vibration, based on the vibration detected by the vibration detector.

### TECHNICAL FIELD

The present invention relates to a saddle-ride vehicle.

### BACKGROUND ART

Conventionally, in motorcycles, a steering damper apparatus has been known that varies damping force applied to a mechanism that turns the steering wheel while the vehicle is running, depending on movement of the vehicle body in the roll direction, yaw direction, etc. (see Japanese Patent Laid-Open No. 2010-228621).

### CITATION LIST

### Patent Literature

### [Patent Literature 1]

Japanese Patent Laid-Open No. 2010-228621

### SUMMARY OF INVENTION

### Technical Problem

However, the conventional steering damper apparatus applies the damping force also due to the movement of the vehicle body caused by the steering of the rider, so that the apparatus may interfere with the steering of the rider.

The present invention has been made in view of the above-mentioned circumstances, and it is an object of the present invention to provide a saddle-ride vehicle that can apply damping force without interfering with steering of a rider.

### Solution to Problem

An aspect of the present invention is a saddle-ride vehicle including a vehicle body including: a handle that steers a steering wheel; vibration detection means that detects vibration of the handle; a steering actuator that applies torque in a steering direction to a suspension apparatus supporting a steering wheel; and a control apparatus that controls the steering actuator, in which the control apparatus performs control to apply torque to the suspension apparatus to suppress the vibration, based on the vibration detected by the vibration detection means.

Note that this description includes all the contents of Japanese Patent Application No. 2021-211367 filed on Dec. 24, 2021.

### Advantageous Effect of Invention

According to an aspect of the present invention, damping force can be applied without interfering with operation of the rider.

### BRIEF DESCRIPTION OF DRAWINGS

FIG. 1 is a side view of a saddle-ride vehicle.

FIG. 2 is a block diagram showing a configuration of a control system.

FIG. 3 is a flowchart of handle vibration damping control in a saddle-ride vehicle.

FIG. 4 is a flowchart regarding cutoff frequency control.

FIG. 5 is a schematic diagram showing a process of controlling cutoff frequency.

### DESCRIPTION OF EMBODIMENT

An embodiment of the present invention will be described below with reference to the drawings. Unless otherwise mentioned, directions including front-rear, left-right, and up-down mentioned in the description are the same as those directions relative to a vehicle body. Reference signs FR, UP, and LH shown in the drawings indicate a vehicle body front side, a vehicle body upper side, and a vehicle body left side, respectively.

### Embodiment

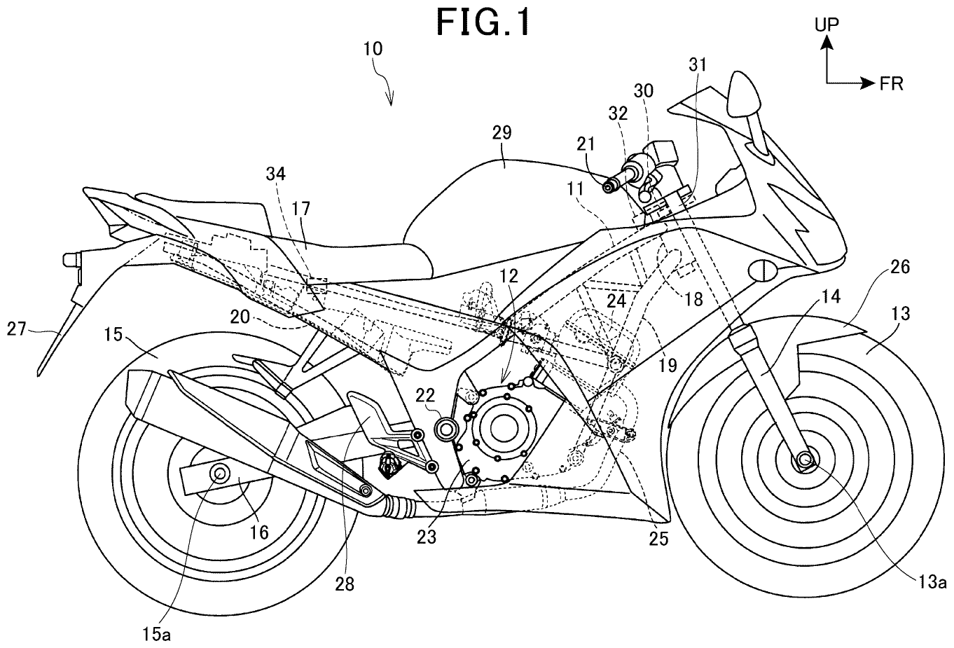

FIG. 1 is a side view of a saddle-ride vehicle 10 according to an embodiment of the present invention.

The saddle-ride vehicle 10 is a vehicle including a vehicle body frame 11, a power unit 12 supported on the vehicle body frame 11, a front fork 14 that supports a front wheel 13 in a steerable manner, a swing arm 16 that supports a rear wheel 15, and a seat 17 for a rider.

The saddle-ride vehicle 10 is a vehicle on which the rider sits astride the seat 17. The seat 17 is provided above a rear part of the vehicle body frame 11.

The vehicle body frame 11 includes a head pipe 18 provided at a front end portion of the vehicle body frame 11, a front frame 19 located on a rear side of the head pipe 18, and a rear frame 20 located on a rear side of the front frame 19. A front end portion of the front frame 19 is connected to the head pipe 18.

The seat 17 is supported on the rear frame 20.

The front fork 14 is supported on the head pipe 18 in such a manner that it can be steered left and right. The front wheel 13 is supported on an axle 13a provided at a lower end portion of the front fork 14. A handle 21 for steering that the rider grasps is mounted at an upper end portion of the front fork 14.

The swing arm 16 is supported on a pivot shaft 22 that is supported on the vehicle body frame 11. The pivot shaft 22 is a shaft extending horizontally in a vehicle width direction. The pivot shaft 22 is passed through a front end portion of the swing arm 16. The swing arm 16 swings up and down around the pivot shaft 22.

The rear wheel 15 is supported on an axle 15a provided at a rear end portion of the swing arm 16.

The power unit 12 is disposed between the front wheel 13 and the rear wheel 15 and supported on the vehicle body frame 11.

The power unit 12 is an internal combustion engine. The power unit 12 includes a crankcase 23 and a cylinder 24 that houses a reciprocating piston. An exhaust device 25 is connected to an exhaust port of the cylinder 24.

An output of the power unit 12 is transmitted to the rear wheel 15 through a drive power transmission member that connects the power unit 12 and the rear wheel 15 to each other.

The saddle-ride vehicle 10 further includes a front fender 26 that covers the front wheel 13 from above, a rear fender 27 that covers the rear wheel 15 from above, footrests 28 on which the rider places his or her feet, and a fuel tank 29 that stores fuel to be used by the power unit 12.

The front fender 26 is mounted on the front fork 14. The rear fender 27 and the footrests 28 are provided on a lower side relative to the seat 17. The fuel tank 29 is supported on the vehicle body frame 11.

The vehicle body 5 includes a front wheel (steering wheel) 13, a suspension apparatus 31, a handle 21 that steers the steering wheel 13, a handle rotation angle detection means (vibration detection means) 32, a steering actuator 30 that applies torque in the steering direction to a suspension apparatus 31 that supports the steering wheel 13, and a control apparatus 34.

The handle rotation angle detection means 32 is provided at the suspension apparatus 31. The handle rotation angle detection means 32 is vibration detection means that detects the rotation angle of the handle 21 over time to detect vibration of the handle 21.

The steering actuator 30 applies torque in the steering direction to the suspension apparatus 31 that supports the steering wheel 13.

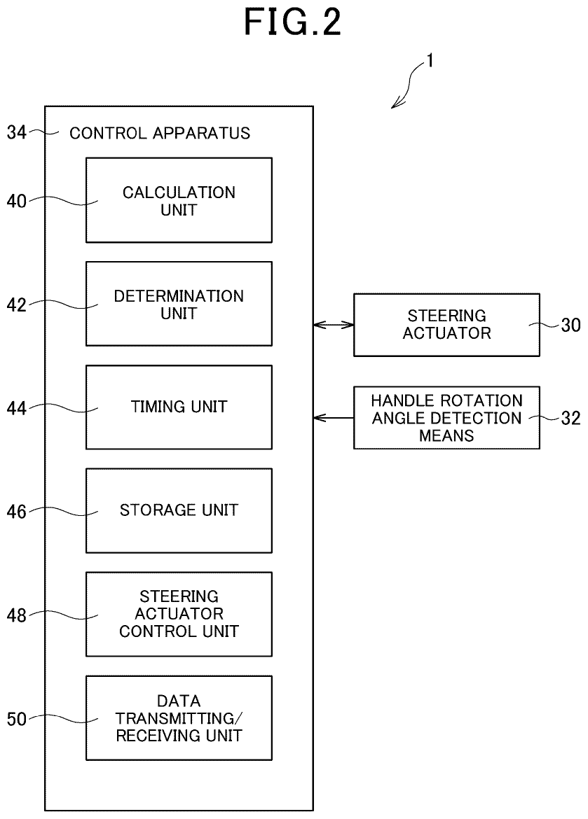

FIG. 2 is a block diagram showing a configuration of a control system 1 in the saddle-ride vehicle 10 according to the present embodiment.

The control apparatus 34 includes a calculation unit 40, a determination unit 42, a timing unit 44, a storage unit 46, a steering actuator control unit 48, and a data transmitting/receiving unit 50.

Specifically, the control apparatus 34 is provided below the seat 17. The control apparatus 34 is an ECU (electronic control unit). The control apparatus 34 includes a CPU (central processing unit), a RAM (random access memory) and a ROM (read only memory), and executes various control. The CPU is a central processing unit, and executes various programs to realize various functions. The RAM is used as a work area and storage area for the CPU, and the ROM stores an operating system and programs executed by the CPU.

The CPU executes a program stored in the storage unit 46 to realize the functions of the determination unit 42.

The calculation unit 40 realizes a function of calculating information regarding the vibration of the handle, specifically, the amplitude and frequency of the vibration of the handle, from the handle rotation angle detected at each time by the handle rotation angle detection means 32.

The determination unit 42 realizes a function or the like of comparing the frequency calculated by the calculation unit 40 with a predetermined threshold and determining whether or not to apply torque to suppress the vibration of the handle 21. Details of the determination processing operation will be described later.

The timing unit 44 has a clock circuit that measures various elapsed times. The timing unit 44 realizes a function of measuring the vibration suppression time etc. that have elapsed since the start of the control to suppress the vibration of the handle 21.

The storage unit 46 stores the threshold values used by the determination unit 42 and also records programs for realizing each function. The storage apparatus included in the storage unit 46 may be, for example, an SSD (solid state device).

The steering actuator control unit 48 realizes a function of controlling the steering actuator 30 that applies torque in the steering direction to the suspension apparatus 31 that supports the handle 21.

The data transmitting/receiving unit 50 includes an interface circuit to be used for exchanging data between the control apparatus 34 and other apparatuses, specifically, the steering actuator 30, the handle rotation angle detection means 32, and the like.

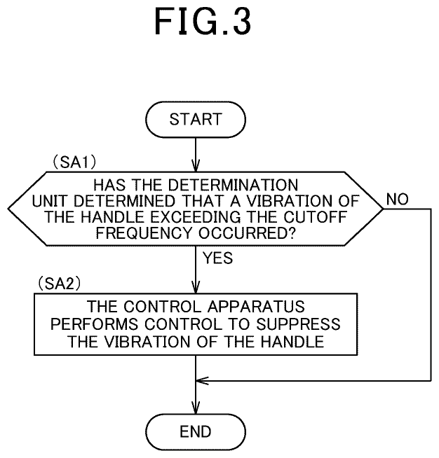

FIG. 3 is a flowchart of handle vibration suppression control in the saddle-ride vehicle 10 according to the present embodiment.

In the control apparatus 34, the determination unit 42 determines whether or not a vibration of the handle exceeding a cutoff frequency has occurred (step SA1). In the present description, the cutoff frequency refers to a frequency that is a threshold that determines whether or not the control apparatus 34 performs control to suppress the vibration of the handle 21. If the determination unit 42 determines that a vibration of the handle exceeding the cutoff frequency has occurred (step SA1: YES), the control apparatus 34 performs control to suppress the vibration of the handle (step SA2). Specifically, the control apparatus 34 controls the steering actuator 30 to apply torque so as to suppress the vibration of the handle 21. In other words, based on the amplitude and phase of the vibration of the handle 21 calculated by the calculation unit 40 from the time change of the rotation angle, the control apparatus 34 performs control that provides the suspension apparatus 31 with torque that gives a vibration with an amplitude similar to that of the vibration of the handle 21 and a phase opposite to that of the vibration of the handle 21 to suppress the vibration. In other words, the control apparatus 34 controls the steering actuator 30 to provide the suspension apparatus 31 with torque corresponding to a damping force that suppresses the vibration of the handle 21.

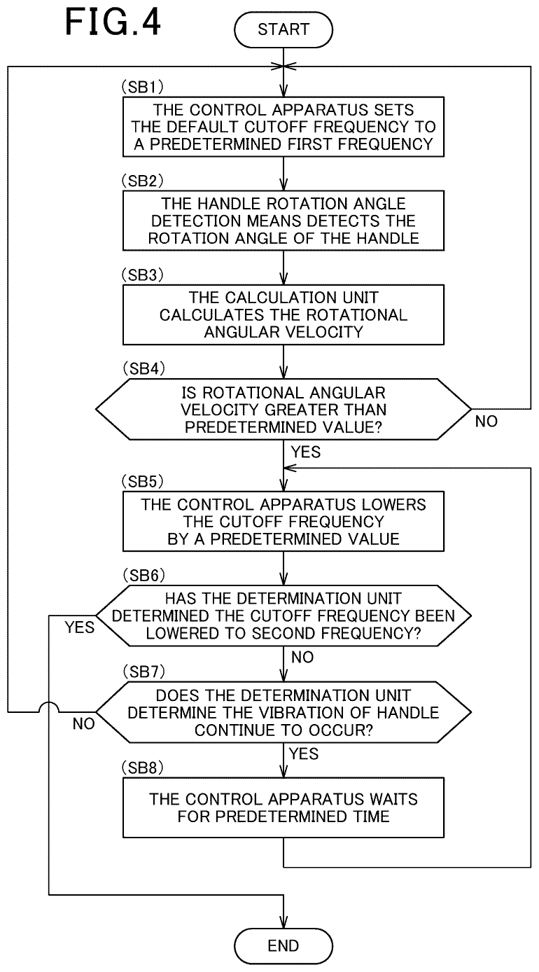

FIG. 4 is a flowchart regarding cutoff frequency control. The control apparatus 34 sets the default cutoff frequency to a predetermined first frequency (step SB1). The first frequency is, for example, 6 Hz. The handle rotation angle detection means 32 detects the rotation angle of the handle 21 at predetermined time intervals (step SB2). Specifically, the rotation angle is detected every 10 msec, for example. The information regarding the rotation angle is received by the control apparatus 34 via the data transmitting/receiving unit 50. The calculation unit 40 calculates the rotational angular velocity from the rotation angle of the handle 21 at each time (step SB3). Of course, the handle rotation angle detection means 32 may directly detect the rotational angular velocity, and the control apparatus 34 may use the data. The determination unit 42 compares the calculated rotational angular velocity with a predetermined value (step SB4). If the rotational angular velocity is greater than the predetermined value (step SB4: YES), the control apparatus 34 lowers the cutoff frequency by a predetermined value (step SB5). The predetermined value is, for example, 0.1 Hz. The determination unit 42 determines whether the cutoff frequency has been lowered to the second frequency (step SB6). The second frequency is, for example, 3 Hz. Performing such control makes the cutoff frequency small to allow the steering actuator 30 to apply torque corresponding to a damping force to the suspension apparatus 31 even for a vibration smaller than the first frequency. If the cutoff frequency has not been lowered to the second frequency (step SB6; NO), the determination unit 42 determines whether the vibration of the handle continues to occur (step SB7). If the determination unit 42 determines that the vibration of the handle continues to occur (step SB7: YES), the control apparatus 34 waits for a predetermined time (step SB8), and then returns to step SB5. Here, for example, the predetermined time is 1 sec.

If the rotational angular velocity is equal to or less than the predetermined value (step SB4: NO), it is highly likely that the rotation of the handle 21 is due to the steering operation by the rider U. Therefore, if the rotational angular velocity is equal to or less than the predetermined value, the process returns to step SB1.

If the cutoff frequency has been lowered to the second frequency (step SB6: YES), the process ends. If the determination unit 42 determines that the vibration of the handle does not continue to occur (step SB7: NO), the process returns to step SB1. That the vibration of the handle does not continue to occur means a case in which a vibration at or above the cutoff frequency does not occur for 3 seconds or more, for example.

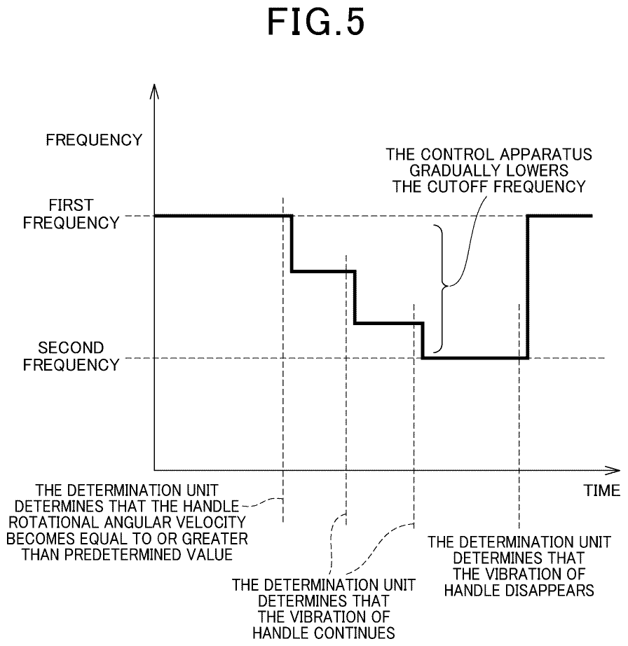

FIG. 5 is a schematic diagram showing a process of controlling the cutoff frequency. The horizontal axis represents time of the control, and the vertical axis represents cutoff frequency. First, in the default state, the cutoff frequency is the first frequency (see step SB1 in FIG. 4). Thereafter, if the determination unit 42 determines that the handle rotational angular velocity has exceeded a predetermined value, the control apparatus 34 lowers the cutoff frequency by a predetermined value. If the determination unit 42 determines that the vibration of the handle continues, the control apparatus 34 gradually lowers the cutoff frequency. If the cutoff frequency has reached the second frequency, the control apparatus 34 fixes the cutoff frequency. After that, if the determination unit 42 determines that the vibration of the handle has disappeared, the control apparatus returns the cutoff frequency to the first frequency.

In the above-described embodiment, the vehicle 10 is described in a case in which it is a motorcycle that is not a scooter-type motorcycle. However, the vehicle may be any saddle-ride vehicle such as a scooter-type motorcycle, a three-wheel type or a four-wheel type called a trike or an ATV, or a four-wheel vehicle.

### (Configuration Supported by the Above Embodiment)

The above embodiments support the following configurations.

### (Configuration 1)

A saddle-ride vehicle including a vehicle body including: a handle that steers a steering wheel; vibration detection means that detects vibration of the handle; a steering actuator that applies torque in a steering direction to a suspension apparatus supporting a steering wheel; and a control apparatus that controls the steering actuator, in which the control apparatus performs control to apply torque to the suspension apparatus to suppress the vibration, based on the vibration detected by the vibration detection means.

According to such a configuration, damping force can be applied without interfering with the operation of the rider. This has an effect of improving operability.

### (Configuration 2)

The saddle-ride vehicle according to Configuration 1, in which the control apparatus: calculates a frequency of vibration of the handle; and applies torque to suppress the vibration of the handle if a frequency of vibration of the handle is equal to or higher than a predetermined threshold.

It is undesirable that the torque application by the steering actuator interfere with steering by the rider. With such a configuration, it is possible to distinguish between the steering by the rider and a vibration of the handle generated by the wobble phenomenon or shimmy phenomenon, to apply torque that damps the latter. This has an effect of improving operability of the vehicle.

### (Configuration 3)

The saddle-ride vehicle according to Configuration 2, in which the control apparatus applies torque to suppress vibration of the handle if a rotational angular velocity of the handle detected by the vibration detection means is greater than a predetermined value.

If the rotational angular velocity of the handle exceeds a predetermined value, it is highly unlikely that the movement is due to the steering operation by the rider. With such a configuration, it is possible to distinguish between the steering of the rider and a vibration of the handle generated by the wobble phenomenon or shimmy phenomenon, to apply torque to damp the latter. This has an effect of improving operability of the vehicle.

### (Configuration 4)

The saddle-ride vehicle according to Configuration 3, in which the control apparatus: includes timing means that measures vibration suppression time that is time elapsed after the control apparatus starts vibration suppression control; and reduces the threshold based on the vibration suppression time.

It is undesirable that the torque application by the steering actuator interfere with steering by the rider. Therefore, the cutoff frequency, which is the frequency that determines whether or not to apply a torque corresponding to the damping force, is set to be high. However, suppressing a vibration lower than the set frequency may improve operability. With such a configuration, if vibration is continuously suppressed for a predetermined time or longer, the cutoff frequency can be lowered. This makes it possible to suppress vibration of the handle even with a lower frequency, and has an effect of improving operability.

The embodiment described above illustrates an aspect of the present invention, and can be modified and applied in any way without departing from the spirit of the present invention.

In addition, the processing units in the flowchart shown in FIG. 3 are divided according to the main processing substance in order to facilitate understanding of the processing of the control apparatus 34, and the present disclosure is not limited by the way of division or the name of the processing unit.

The processing of the control apparatus 34 can be divided into more processing units depending on the processing substance, or can be divided so that one processing unit includes even more processing. Furthermore, the processing order in the above flowchart is also not limited to the illustrated example.

### REFERENCE SIGNS LIST

1 control system
5 vehicle body
10 saddle-ride vehicle
21 handle
30 steering actuator
31 suspension apparatus
32 handle rotation angle detection means (vibration detection means)
34 control apparatus
44 timing means

1. A saddle-ride vehicle comprising a vehicle body including:
a handle that steers a steering wheel;
vibration detector that detects vibration of the handle;
a steering actuator that applies torque in a steering direction to a suspension apparatus supporting a steering wheel; and
a control apparatus that controls the steering actuator,
wherein the control apparatus:
performs control to apply torque to the suspension apparatus to suppress the vibration, based on the vibration detected by the vibration detector; and
applies torque to suppress vibration of the handle if a rotational angular velocity of the handle detected by the vibration detector is greater than a predetermined value.

2. The saddle-ride vehicle according to claim 1, wherein the control apparatus:
calculates a frequency of vibration of the handle; and
applies torque to suppress the vibration of the handle if the frequency of vibration of the handle is equal to or higher than a predetermined threshold.

3. The saddle-ride vehicle according to claim 2, wherein the control apparatus:
includes timer that measures vibration suppression time that is time elapsed after the control apparatus starts vibration suppression control; and
reduces the threshold based on the vibration suppression time.

4. The saddle-ride vehicle according to claim 1, wherein the control apparatus:
continuously performs control to apply torque to suppress the vibration if vibration is applied to the handle; and
ends control for applying torque to suppress the vibration if the vibration of the handle is no longer detected.
